(19) United States
(12) Patent Application Publication
(10) Pub. No.: US 2006/0078259 A1
(43) Pub. Date: Apr. 13, 2006

(54) Latching mechanism for small form factor pluggable modules

(75) Inventor: Christopher Fuchs, Exton, PA (US)

Correspondence Address: Wendy W. Koba, P.O. Box 556, Springtown, PA, 18081, US

(73) Assignee: TriQuint Technology Holding Co.

(21) Appl. No.: 10/962,686

(22) Filed: Oct. 12, 2004

(51) Int. Cl. G02B 6/36

(52) U.S. Cl. 385/88; 385/92

(57) ABSTRACT

A latching mechanism for releasably engaging an optical module with an outer housing (referred to as a “cage”) includes a bail handle that is pivotally attached to a front end of the optical module, allowing the bail handle to rotate between a first, engaged position and a second, disengaged position. The bail handle includes a pair of slide arms that move along the sidewalls of the optical module as the bail handle is rotated, the slide arms moving backward to affect disengagement and moving forward to affect engagement between the optical module and the housing. The optical module includes a pair of channels that support the pair of slide arms as they move between the engaged/disengaged positions such that when the pair of slide arms is in the forward, engaged position, the end portion of each channel is exposed such that a pair of locking tabs formed on the housing will enter the end portions and provide the engagement of the optical module to the housing.

### TECHNICAL FIELD

The present invention relates to a pluggable optical module and, more particularly, to a bail latch mechanism with a low profile to allow for the module to be plugged into and out of an associated housing.

### DESCRIPTION OF THE PRIOR ART

Fiber optic transceivers facilitate bi-directional data transmission between various types of electronic devices and optical data links in fiber optic communication systems. Each transceiver includes a photodetector (and associated electronic circuitry) for converting optically encoded data received from an optical data link into electrically encoded data readable by a host electronic device, as well as a laser diode (and associated electronic circuitry) for converting electrically encoded data signals from the host electronic device into optical signals that are transmitted across the optical data link into the fiber optic communication system. Each transceiver is mounted onto a circuit card assembly of the host electronic device, and is therefore typically packaged such that it occupies as little circuit card surface area as possible.

In preferred arrangements, the transceiver module is “plugged” into the circuit card through a “cage” that is attached to the circuit card itself. Various dimensions and operating characteristics of both the transceiver cage and transceiver module have been standardized, as defined in the “Cooperation Agreement for Small Form-Factor Pluggable Transceivers”, executed on Sep. 14, 2000. In particular, the Cooperation Agreement sets forth transceiver package dimensions, cage and electrical connector specifications, host circuit board layouts, electrical interface specifications and front panel bezel requirements that need to be followed by each manufacturer that is a party to the Cooperation Agreement. Within the confines of this Agreement, however, manufacturers remain free to design the various components in any manner found to be suitable.

With the advent of “hot pluggable” transceivers (i.e., transceivers that are plugged “in” and “out” while the circuit card remains powered), latching devices have become a popular safety feature to ensure that the transceiver module is securely held within the cage until purposely removed. Bail latching devices (also referred to simply as a “bail”) have become particularly popular, due to their functional and ergonomic advantages. Previous bail designs are disclosed in, for example, U.S. Pat. No. 5,901,263 issued to IBM Corp. and U.S. Pat. No. 6,439,916 issued to Finisar Corp. The bail in the IBM device forces plastic arms, which are normally biased inwardly, outwardly into engagement with the cage. The bail in the Finisar device pivots a separate pivoting latch member, which is normally biased into engagement with the cage by a specially designed extension of the housing. Both of these devices exhibit a rather large profile (taking up valuable space within the module structure) and require specially designed housings. The Finisar device in particular requires a complex assembly process to ensure that the bail, the pivoting latch member and the housing all interact correctly.

The need remaining in the prior art, therefore, is for a simpler bail latching device with fewer movable parts and a reduced profile, providing a more robust structure and facilitating an easier assembly process.

### BRIEF DESCRIPTION OF THE DRAWINGS

Referring now to the drawings, where like numerals represent like parts in several views:

FIG. 1 illustrates, in an “unlocked” isometric view, an exemplary transceiver package using the bail latch mechanism of the present invention;

FIG. 2 illustrates, in a “locked” isometric view, an exemplary transceiver packing using the bail latch mechanism of the present invention;

FIG. 3 illustrates, in a simplified and exploded view, a system arrangement utilizing a “pluggable” module in association with a cage and a host board; and

FIG. 4 is an isometric view of a portion of a transceiver module in the “locked” position, particularly illustrating the position of the bail and the slide arms.

### DETAILED DESCRIPTION

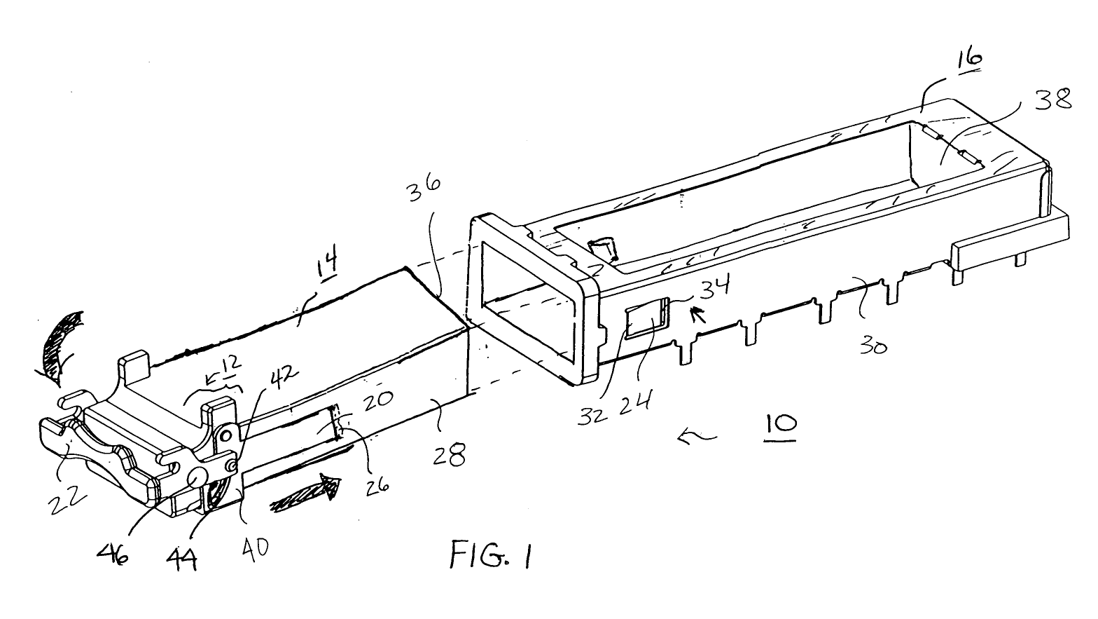

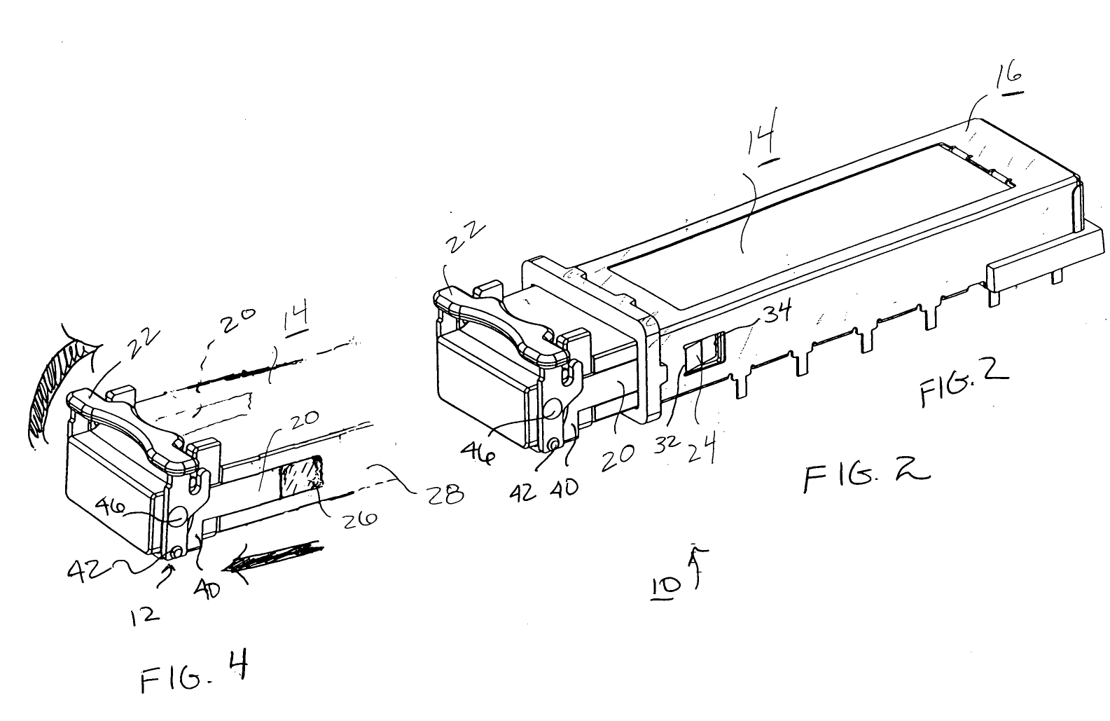

FIGS. 1 and 2 illustrate, in isometric views, an exemplary transceiver package 10 including a latching mechanism 12 formed in accordance with the present invention. FIG. 1 illustrates package 10 in the “unlocked” position, with a transceiver module 14 fully disengaged from a “cage” 16. FIG. 2 illustrates the same package 10 in the “locked position”, with transceiver module 14 fully engaged within cage 16. As is well-known in the art, a cage may be used to facilitate the placement and location of a “pluggable” unit (such as, for example, a transceiver, transmitter, receiver, or the like) within a host board associated with a larger system.

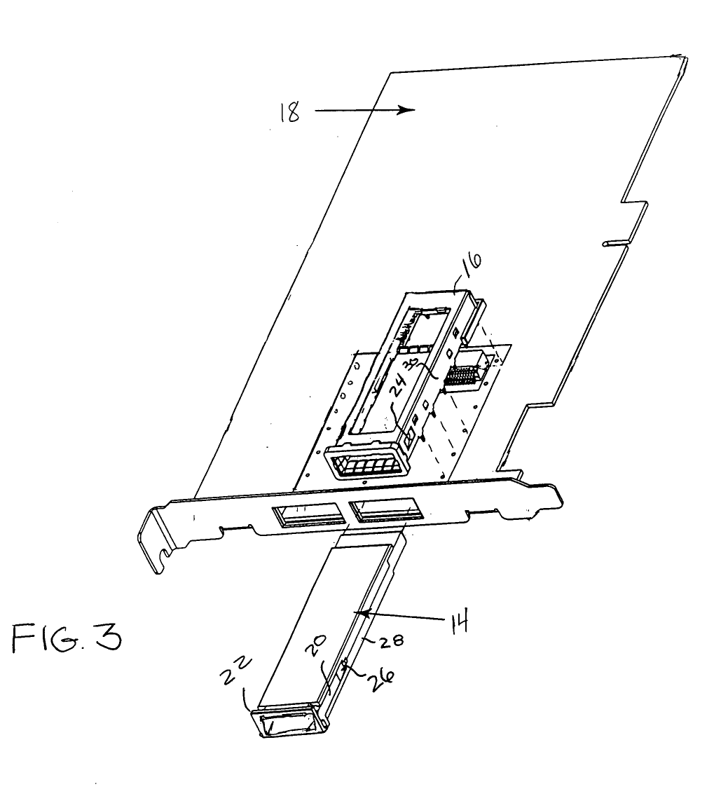

FIG. 3 illustrates, in an exploded view, the relationship between transceiver module 14, cage 16 and an exemplary host board 18. FIG. 4 contains a partial isometric view of transceiver module 14 in the locked position, where the view of FIG. 4 clearly illustrates the movement of slide arms 20 as controlled by a bail 22 so as to result in the engagement of locking tabs 24 (as shown in FIG. 3) with a pair of recessed channels 26 in sidewalls 28 of transceiver module 14. It is to be understood that similar arm and channel components are formed on the opposite side of transceiver module 14, although the view of these components is blocked by the isometric perspective of the illustrations.

In particular, and with reference to the above figures, the action of the bail latching mechanism 12 of the present invention will now be described in detail. As mentioned above, FIG. 1 illustrates the mechanism in the unlocked position. When in this position, transceiver module 14 can freely move into and out of cage 16. This freedom of movement is attributed to the position of slide arms 20 as fully extended along their associated cavities 26 (cavities 26 being clearly illustrated in FIG. 4). With slide arms 20 in this fully extended position, locking tabs 24 formed within sidewalls 30 of cage 16 remain essentially collinear with their associated sidewalls and therefore do not impede the movement of module 14 into and out of cage 16. Referring to FIG. 1, locking tab 24 is illustrated as attached to sidewall 30 along a first edge 32. An opposing edge 34 of locking tab 24 is free to move, and is biased to move in towards the interior region of cage 16, as indicated by the arrow. comes into contact with rear inward surface 38 of cage 16. In accordance with the present invention, once transceiver module 14 is in place, bail 22 is rotated upward which results in moving slide arms 20 forward, as shown in FIG. 4. The movement of slide arms 20 exposes end portions of channels 26, allowing locking tabs 24 to enter channels 26 and thus “lock” transceiver module 14 in place.

Referring to FIGS. 1 and 4, bail 22 is shown as attached to slide arms 20 through a mechanism that translates the rotational movement of bail 22 into a longitudinal movement of slide arms 22. In particular, the translational movement is affected by an arcuate end portion 40 formed at the termination of each slide arm 20. A locator pin 42 is formed at each endpoint of bail 22 and is disposed to ride along a curved surface 44 of arcuate end portion 40, as shown in FIG. 1. A pivot pin 46 is formed along each side of bail 22 and is used to attach bail 22 to transceiver module 14 in a manner such that bail 22 may be easily rotated between the upward (locked) position and the horizontal (unlocked) position. That is, pivot pins 46 allow for bail 22 to be rotated upward, where the upward rotation of bail 22 results in locator pins 42 moving downward along curved surface 44 of arcuate end portion 40. The downward movement of locator pins 42 is then translated into horizontal movement of slide arms 20, as particularly shown in FIG. 4, exposing channel regions 26. FIG. 2 illustrates the arrangement in the locked position, where bail 22 is shown in the upward position and locking tabs 24 are illustrated as fully engaged within channels 26.

In the arrangement of the present invention, a minimal profile is needed for the latching mechanism, since with slide arms 20, bail movement resides in one plane (along transceiver sidewall 28), allowing locking tabs 24 to be pressed out only a sufficient amount to re-align with cage sidewall 30. Consequently, transceiver module 14 will remain locked within cage 16 when channels 26 have a relatively minimal depth. The minimal depths of channels 26, coupled with the translation movement of slide arms 20 to affect the locking function results in the formation of a bail latching mechanism with a relatively low profile, thus requiring less space than prior art bail latching mechanisms. Advantageously, this arrangement easily complies with the requirements of the Cooperation Agreement in terms of providing a “small form-factor pluggable transceiver”, in this case with a relatively low profile locking arrangement. This lower profile thus provides additional packaging space for the internal transceiver components.

While the arrangement of the present invention has been illustrated in terms of using the inventive bail latch mechanism to engage/disengage a transceiver module with a cage, it is to be understood that the same/similar bail latch mechanism can be used with any pluggable module that is required to be releasably mated with a host board. For example, transmitter modules or receiver modules may be formed to include the same bail latch mechanism. Indeed, the scope of the present invention is intended to be limited only by the scope of the claims appended hereto.

What is claimed is:

1. A pluggable optical packaging arrangement comprising:
a housing for electrical connection to a host communication circuit board, the housing having an open front wall and a pair of sidewalls, and including an open interior region, with a pair of locking tabs disposed in opposition on the pair of sidewalls;
an optical module for engaging/disengaging with the housing through the open front wall so as to occupy the open interior region thereof, the optical module including a latching mechanism for releasably engaging the optical module with the housing, the latching mechanism comprising
a bail handle pivotally attached to a front end of the optical module so as to rotate between a first, engaged position and a second, disengaged position;
a pair of slide arms attached to the bail handle, the pair of slide arms fixed to the bail handle so as to move along the sidewalls of the optical module as the bail handle is rotated, the slide arms moving backwards toward the housing open interior region to affect disengagement and moving forward to affect engagement between the optical module and the housing; and
a pair of channels formed along the sidewalls of the optical module for supporting the pair of slide arms, wherein when the pair of slide arms are in the forward, engaged position, the end portion of each channel is exposed such that the pair of locking tabs formed on the housing will enter the end portions and provide the engagement of the optical module to the housing.

2. A pluggable optical packaging arrangement as defined in claim 1 wherein the latching mechanism further comprises:
arcuate end portions formed on the pair of slide arms; and
a pair of locator pins attached to end portions of the bail handle and disposed so as to ride along the arcuate end portions of the pair of slide arms and translate the pair of slide arms between the rearward, disengaged position and the forward, engaged position.

3. A pluggable optical packaging arrangement as defined in claim 1 wherein the optical module comprises a transceiver module.

4. A pluggable optical packaging arrangement as defined in claim 1 wherein the optical module comprises a transmitter module.

5. A pluggable optical packaging arrangement as defined in claim 1 wherein the optical module comprises a receiver module.

6. A latching mechanism for releasably engaging an optical module with an outer housing, the latching mechanism comprising:
a bail handle pivotally attached to a front end of the optical module so as to rotate between a first, engaged position and a second, disengaged position;
a pair of slide arms attached to the bail handle, the pair of slide arms fixed to the bail handle so as to move along the sidewalls of the optical module as the bail handle is rotated, the slide arms moving backward to affect disengagement and moving forward to affect engagement between the optical module and the housing; and
a pair of channels formed along the sidewalls of the optical module for supporting the pair of slide arms, wherein when the pair of slide arms is in the forward, engaged position, the end portion of each channel is exposed such that a pair of locking tabs formed on the housing will enter the end portions and provide the engagement of the optical module to the housing.

7. A latching mechanism as defined in claim 6 wherein the latching mechanism further comprises:
arcuate end portions formed on the pair of slide arms; and
a pair of locator pins attached to end portions of the bail handle and disposed so as to ride along the arcuate end portions of the pair of slide arms and translate the pair of slide arms between the rearward, disengaged position and the forward, engaged position as the bail handle is rotated between the second, disengaged position and the first, engaged position.
